(19) United States
(12) Patent Application Publication
(10) Pub. No.: US 2017/0341959 A1
(43) Pub. Date: Nov. 30, 2017

(54) WATER TREATMENT USING A CRYPTOCRYSTALLINE MAGNESITE - BENTONITE CLAY COMPOSITE

(71) Applicant: CSIR, Pretoria (ZA)

(72) Inventors: Masindi VHAHANGWELE, Mukula (ZA); Wilson Mugera GITARI, Louis Trichardt (ZA)

(21) Appl. No.: 15/534,046

(22) PCT Filed: Aug. 17, 2015
(86) PCT No.: PCT/ZA2015/050004

§ 371 Date: Jun. 8, 2017

(30) Foreign Application Priority Data
May 21, 2015 (ZA) 2015/03623

(51) Int. Cl. C02F 1/52; C02F 1/66; C02F 103/10; C02F 1/00; C02F 101/20; C02F 101/10

(52) U.S. Cl. CPC C02F 1/5236; C02F 1/5263; C02F 1/66; C02F 2101/108; C02F 2101/106; C02F 1/001; C02F 2101/101; C02F 2101/20; C02F 2103/10; C02F 2101/103

(57) ABSTRACT

A process for the treatment of contaminated water includes contacting the contaminated water with a cryptocrystalline magnesite-bentonite clay composite thereby to remove one or more contaminants from the water. The invention extends to a method for the manufacture of a cryptocrystalline magnesite-bentonite clay composite wherein an admixture of cryptocrystalline magnesite and bentonite clay is milled to a desired particle size with amorphization of the magnesite and bentonite clay in the resultant cryptocrystalline magnesite-bentonite clay composite, and to a cryptocrystalline magnesite-bentonite clay composite.

### FIELD OF THE INVENTION

This invention relates to the treatment of water, e.g. acid mine drainage. In particular, the invention relates to a process for the treatment of contaminated water, such as acidic and metalliferous mine drainage, to a method for the manufacture of a cryptocrystalline magnesite-bentonite clay composite, and to a cryptocrystalline magnesite-bentonite clay composite

### BACKGROUND OF THE INVENTION

Contaminated or polluted water, such as acidic and metalliferous drainage originating from metal mining activities can cause serious environmental pollution. On release to receiving aquatic ecosystems, acid mine drainage (AMD) can cause major ecological impacts which have the capability to compromise the integrity of terrestrial and aquatic ecosystems to sustain life.

AMD is generated by oxidation of sulphide bearing minerals such as FeAsS, FeₓSₓ, CuS, Cu₂S, CuFeS₂, MoS₂, NiS, ZnS and PbS in the presence of air and water. More prevalently, pyrite associated with coal and gold seams and many ores including copper, silver, uranium and zinc is the main source of AMD. During mining processes, sulphide-rich rocks are exposed to water and oxygen and this promotes the formation of AMD. During rainfall on tailings dumps and rising groundwater in disused mineshafts, water and oxygen interacts with sulphidic minerals leading to the formation of acidic effluent. The resultant acidic water accelerates leaching of metals from surrounding rock strata or tailings.

The release of metals to effluent waters makes the water metalliferous. In most instances, the formation of AMD can be represented by the following chemical equations, using pyrite as an example:

$$\begin{matrix}2 {FeS}_{2 ( s )} + 7 {O}_{2 ( g )} + 2 {H}_{2} O {}^{bac teria} 2 {Fe}_{( aq )}^{2 +} + 4 {H}_{( aq )}^{+} + 4 {SO}_{4 ( aq )}^{2 -} & ( 1 ) \\ 4 {Fe}_{( aq )}^{2 +} + {O}_{2 ( g )} + 4 {H}_{( aq )}^{+} -> 4 {Fe}_{( aq )}^{3 +} + 2 {H}_{2} {O}_{1} & ( 2 ) \\ {FeS}_{2 ( s )} + 14 {Fe}^{3 +} + 8 {H}_{2} O -> 15 {Fe}^{2 +} + 2 {SO}_{4 ( I )}^{2 -} + 16 {H}^{+} & ( 3 ) \\ {Fe}_{( aq )}^{3 +} + 3 {H}_{2} {O}_{1} -> {Fe ( OH )}_{3 ( s )} + 3 {H}_{( aq )}^{+} & ( 4 )\end{matrix}$$

These reactions are also mediated by bacteria (Equation 1). Acidic and metalliferous drainage is a prime issue of environmental concern since it causes a reduction in biodiversity and loss of authentic value of pristine ecosystems. Acid mine drainage is characterised by high acidity and elevated concentrations typically of Al, Fe, Mn and SO₄²⁻. In addition, it typically also contains trace amounts of As, B, Cr, Cu, Co, Mo, Ni, Pb, Se, and Zn.

This mine effluent needs to be contained and treated before discharge to natural water bodies. Several technologies have been developed for treatment of AMD and these include ion-exchange, adsorption, precipitation, and phytoremediation. The use of limestone for treatment of acid mine drainage has been investigated. Biological agents were also used for removal of sulphates from acid mine drainage as a polishing step. Due to cost implications, inefficient treatment, selective treatment and generation of toxic sludge, the existing technologies have limitation and companies are in constant search for sustainable AMD treatment and management technologies. To date, limestone has been used for AMD treatment but has limitations of raising the pH to a maximum of 7 which is not sufficient to remove all metal pollutants in AMD, and additional liming is necessary, thus making it unsustainable. Moreover limestone treatment leads to generation of huge amounts of sludge that has to be managed. South African bentonite clay has been evaluated for AMD treatment but was observed to have low metal removal efficiency especially at high concentrations and could only increase the pH of the reaction mixture≈4 which is not sufficient for precipitation of metal species.

Clay have excellent physicochemical properties such as high adsorption capacities, ion exchange capacities, swelling properties, surface area, leafy or lamella structure, abundance and low cost. Clay minerals have also received great attention as alternative material for decontamination of polluted water bodies. In addition, these materials are environmentally friendly, abundant, versatile and readily available making their application economically sustainable. Techniques such as intercalation and pillaring, acid activation and mechanochemical activation can be employed in an attempt to improving the adsorption and inorganic contaminants removal properties of the clays. The preparation of organoclays by grafting and direct synthesis has also been used for metals retention.

Amongst all clay modifications and composite synthesis science, mechanochemical activation was reported to present good responses because it is cheap, economically viable and an environmentally friendly technique of modification. Documented literature has meticulously described the influence of mechanochemical activation on the morphological and microstructural alterations and improvements of the clay, but only a limited number of research studies have investigated the use of mechanical milling on their adsorption and reactivity properties. Moreover, at least one study observed that bentonite clay being a geological material possessed free alkaline materials that can be released on mechanochemical activation and be made available to increase the pH of the reaction mixture. Fragmentation, distortion, breakage of crystalline networks and cobwebs, and particle size reduction followed by an increase of the surface area, exfoliation of particles and amorphization, can lead to the increase of the removal efficiencies of pollutants on fabricated composites.

Clay has been widely used for removal of inorganic and organic contaminants from aqueous systems. The main mode of metals attenuation by clay is adsorption. Adsorption of inorganic chemical species on clay minerals is highly pH dependent, thus, limiting their application in wastewater amelioration (pH<4). In an attempt to counter for the limitations in the use of the raw and modified clays as adsorbents, the adsorbents can be prepared in a composite form with some metal oxides and carbonates. To respond to the challenges that have been presented by current technologies, government, mining houses, and scientific communities are seeking for innovative and locally available technologies for remediating AMD.

It is accordingly an object of the present invention to synthesize a composite adsorbent, and to provide a process for the treatment of water, e.g. contaminated water polluted with industrial waste or metals, or water that can be considered to be AMD. It will be a particular advantage if such a composite adsorbent has the ability to neutralise acidity and to remove metal species and sulphate from metalliferous mine drainage in a single process step.

### SUMMARY OF THE INVENTION

According to one aspect of the invention, there is provided a process for the treatment of contaminated water, the process including contacting the contaminated water with a cryptocrystalline magnesite-bentonite clay composite thereby to remove one or more contaminants from the water.

In this specification, the term “bentonite” is intended to refer broadly to a clay material which has at least 50% by weight smectite. Preferably, the clay material has at least 60% by weight, more preferably at least 70% by weight, most preferably at least 80% by weight smectite.

The term “smectite” is intended to refer to a family of expansible 2:1 phyllosilicate clay minerals (swelling clays) having permanent layer charge because of the isomorphous substitution in either a octahedral sheet or a tetrahedral sheet. It is common for smectites to have both tetrahedral charge and octahedral charge.

The contaminated water may be acidic, i.e. the contaminated water may have a pH of less than 7.

The contaminated water may comprise metal or metalloid ions as contaminants. Contacting the contaminated water with a cryptocrystalline magnesite-bentonite clay composite may include mixing particulate cryptocrystalline magnesite-bentonite clay composite with the contaminated water thereby to remove at least some of the metal or metalloid ion contaminants from the water.

In one embodiment of the invention, the method includes separating treated water from the cryptocrystalline magnesite-bentonite clay composite, e.g. using filtration.

Contacting the contaminated water with a cryptocrystalline magnesite-bentonite clay composite thereby to remove one or more contaminants from the water may instead include passing the contaminated water through a bed of the cryptocrystalline magnesite-bentonite clay composite.

The contaminated water may comprise oxyanions, e.g. sulphate, of one or more elements selected from the group consisting of arsenic, chromium, boron, selenium and molybdenum. Said oxyanions may be removed from the contaminated water by contact with the cryptocrystalline magnesite-bentonite clay composite.

Contacting the contaminated water with cryptocrystalline magnesite-bentonite clay composite may include using sufficient cryptocrystalline magnesite-bentonite clay composite to raise the pH of the water to >10, preferably to between 10 and 12, more preferably to between 10 and 11.

The metal ions removed from the water as contaminants may be selected from the group consisting of Al, Mn, Ca, and Fe ions.

Instead, or in addition, the metal ions removed from the water as contaminants may be divalent ions selected from the group consisting of Co(II), Cu(II), Ni(II), Pb(II) and Zn(II).

The cryptocrystalline magnesite-bentonite clay composite is typically in particulate or powdered form. The cryptocrystalline magnesite-bentonite clay composite may have a particle size such that the particulate cryptocrystalline magnesite-bentonite clay composite is able to pass through a 125 μm particle size sieve, preferably through a 75 μm particle size sieve, more preferably through a 50 μm particle size sieve, most preferably through a 40 μm particle size sieve. The powdered or particulate composite may for example have a maximum particle size of about 32 μm so that it passes through a 32 μm particle size sieve.

The contaminated water may be contacted with cryptocrystalline magnesite-bentonite clay composite at a solid/liquid ratio of 0.5 kg-10 kg:10L-150L, preferably at a solid/liquid ratio of 0.5 kg-5 kg:10L-150L.

The contaminated water may be contacted with cryptocrystalline magnesite-bentonite clay composite for 10 to 80 minutes, preferably 20 to 50 minutes, more preferably 30 to 40 minutes.

The contaminated water may be acid mine drainage (AMD), i.e. an acidic and metalliferous mine drainage. The acidic and metalliferous mine drainage typically includes inorganic contaminants selected from the group consisting of Fe³⁺, Al³⁺, Mn²⁺ and SO₄²⁻ in the form of Fe₂(SO₄)₃.H₂O, Al₂(SO₄)₃.18H₂O, MnCl₂ and H₂SO₄.

The contaminated water may be industrial waste water containing metal or metalloid ions. The industrial waste water may comprise divalent metal ions. The divalent metal ions may be selected from the group consisting of Co(II), Cu(II), Ni(II), Pb(II) and Zn(II).

The oxyanions may be selected from the group consisting of sulphates, phosphates and nitrates. In one embodiment of the invention, the oxyanions are sulphates.

The cryptocrystalline magnesite-bentonite clay composite may have a magnesite-bentonite clay mass ratio of at least 0.2:1, preferably at least 0.5:1, more preferably at least 0.8:1, even more preferably at least 0.9:1, most preferably at least 1:1. Typically, the magnesite-bentonite clay mass ratio is less than 4:1, preferably less than 3:1, more preferably less than 2:1, e.g. about 1:1.

The contaminated water may comprise sulphate at a concentration of up to 6000 mg/L. The cryptocrystalline magnesite-bentonite clay composite may remove at least 60%, preferably at least 70%, more preferably at least 75%, most preferably at least 80% of the sulphate from the contaminated water.

The cryptocrystalline magnesite-bentonite clay composite may be at least in part from magnesite tailings from a cryptocrystalline magnesite mining operation, or may be obtained at least in part from a magnesite tailings dam.

Bentonite is defined as a naturally occurring material that is composed predominantly of the clay mineral smectite. The smectite in most bentonites is the mineral montmorillonite, which is a dioctahedral smectite but occasionally other types of smectite may be present. It is the presence of smectite which imparts the desirable properties to bentonites, although associated factors such as the nature of the exchangeable cations in the interlayer also affect properties. Most commercial bentonites contain more that 80% smectite, however, a wide variety of other minerals may occur as impurities. As shown in the table below, which provides an XRD analysis of a sample of cryptocrystalline magnesite tailings collected from the Folovhodwe Magnesite Mine (Nyala mine) in Limpopo Province, South Africa, the tailings typically includes smectite, i.e. bentonite clay. Values are given in wt %.

| Sample | Calcite | Dolomite | Orthopyroxene | Plagioclase | Quartz | Mica | Talc | Magnesite | Smectite |
|---|---|---|---|---|---|---|---|---|---|
| Magnesite | — | 9 | 5 | 6 | trc | 2 | 2 | 63 | 13 |
| tailings | | | | | | | | | |

According to another aspect of the invention, there is provided a method for the manufacture of a cryptocrystalline magnesite-bentonite clay composite, the method including

milling an admixture of cryptocrystalline magnesite and bentonite clay to a desired particle size with amorphization of the magnesite and bentonite clay in the resultant cryptocrystalline magnesite-bentonite clay composite.

The method may include admixing cryptocrystalline magnesite powder and bentonite clay powder to provide said admixture.

Instead, the cryptocrystalline magnesite and bentonite clay admixture may be obtained at least in part from magnesite tailings from a cryptocrystalline magnesite mining operation, or may be obtained at least in part from a magnesite tailings dam.

Typically, the cryptocrystalline magnesite powder and bentonite clay powder are dry. If necessary, the method may include drying one or both of said powders, or magnesite tailings from a cryptocrystalline magnesite mining operation or from a magnesite tailings dam.

The cryptocrystalline magnesite powder and the bentonite clay powder may be admixed in a mass ratio of at least 0.2:1, preferably at least 0.5:1, more preferably at least 0.8:1, even more preferably at least 0.9:1, most preferably at least 1:1. Typically, the cryptocrystalline magnesite powder and the bentonite clay powder is admixed in a mass ratio of less than 4:1, preferably less than 3:1, more preferably less than 2:1, e.g. about 1:1.

The cryptocrystalline magnesite powder and the bentonite clay powder being admixed may each have a particle size of less than 125 μm, preferably less than 75 μm, more preferably less than 50 μm, most preferably less than 40 μm, e.g. about 32 μm. If necessary, the method of the invention may include comminuting, e.g. milling, cryptocrystalline magnesite and/or bentonite clay to achieve a powder of desired fineness.

The method may include washing the bentonite clay, e.g. in ultra-pure water, before it is milled into a fine powder. The washed bentonite clay may be dried, e.g. at a temperature of 105° C.

The milling of the admixtures, i.e. a mechanochemical synthesis of the composite, typically renders the cryptocrystalline magnesite-bentonite clay composite substantially free of at least one of brucite, fosterite, calcite and plagioclase, where substantially free means less than 2% by mass concentration.

The milled cryptocrystalline magnesite-bentonite clay composite may have a reduced concentration of at least one of periclase, smectite, quartz and muscovite compared to the concentration in magnesite for periclase and the concentration in bentonite clay for smectite, quartz and muscovite.

The resultant powdered or particulate cryptocrystalline magnesite-bentonite clay composite may have a particle size such that the particulate cryptocrystalline magnesite-bentonite clay composite is able to pass through a 125 μm particle size sieve, preferably through a 75 μm particle size sieve, more preferably through a 50 μm particle size sieve, most preferably through a 40 μm particle size sieve. The powdered or particulate composite may for example have a maximum particle size of about 32 μm so that it passes through a 32 μm particle size sieve.

According to a further aspect of the invention, there is provided a cryptocrystalline magnesite-bentonite clay composite comprising a powdered admixture of cryptocrystalline magnesite powder and bentonite clay powder with a magnesite-bentonite clay mass ratio of at least 0.2:1.

The magnesite-bentonite clay mass ratio may be at least 0.5:1, preferably at least 0.8:1, more preferably at least 0.9:1, most preferably at least 1:1.

The cryptocrystalline magnesite-bentonite clay composite may be substantially free of at least one of brucite, fosterite, calcite and plagioclase, where substantially free means less than 2% by mass concentration.

The powdered or particulate cryptocrystalline magnesite-bentonite clay composite may have a particle size such that the particulate cryptocrystalline magnesite-bentonite clay composite is able to pass through a μm particle size sieve, preferably through a 75 μm particle size sieve, more preferably through a 50 μm particle size sieve, most preferably through a 40 μm particle size sieve. The powdered or particulate composite may for example have a maximum particle size of about 32 μm so that it passes through a 32 μm particle size sieve.

Typically, the cryptocrystalline magnesite includes magnesite, periclase, brucite, quartz and forsterite as the main mineral phases.

Typically, the bentonite clay includes montmorillonite, quartz, calcite and muscovite.

The cryptocrystalline magnesite-bentonite clay composite may include montmorillonite, quartz, dolomite, calcite, brucite, periclase and muscovite.

Magnesite is a mineral most commonly of white colour. Individual crystals are not visible in polarized light under an optical microscope. Magnesite ores are divided into three varieties, namely, massive, banded and brecciated. Each of the magnesite varieties is located in specific places of the geologic section or is typical for individual deposits. A magnesite body consists of massive and brecciated magnesite ores. Central parts of the magnesite body are represented by massive amorphous magnesite with a high content of MgO up to 87-90%.

Naturally, magnesite is found in two forms, namely, crystalline and cryptocrystalline, which is more amorphous and less crystalline than crystalline magnesite, but which has a microscopic crystalline structure. Different forms of magnesite have different X-ray characteristics. For example, crystalline magnesite usually shows a double sharp peak at 2.74 and 2.70 A, whereas cryptocrystalline magnesite usually has a broader peak at 2.74 A and a weak shoulder at 2.70 A. In contrast, an amorphous material will not show peaks on XRD. Cryptocrystalline magnesites are more heterogeneous than crystalline magnesites and typically include free silica. Other differences between cryptocrystalline and crystalline magnesites are discussed by Nasedkin et al. (Nasedkin V. V, Krupenin M. T., Safonov Yu. G, Boeva N. M, Efremova S. V. and Shevelev A. I. 2001 The comparison of amorphous (cryptocrystalline) and crystalline magnesites. Mineralia Slovaca, 33 (2001), 567-574). This document is incorporated herein by reference.

The invention extends to a cryptocrystalline magnesite-bentonite clay composite comprising a powdered mixture of cryptocrystalline magnesite and bentonite clay which has a particle size such that the particulate cryptocrystalline magnesite-bentonite clay composite is able to pass through a 125 μm particle size sieve.

The cryptocrystalline magnesite-bentonite clay composite may have a particle size such that the particulate cryptocrystalline magnesite-bentonite clay composite is able to pass through a 75 μm particle size sieve, preferably through a 50 μm particle size sieve, more preferably through a 40 μm particle size sieve.

The magnesite-bentonite clay mass ratio may be at least 0.5:1, preferably at least 0.8:1, more preferably at least 0.9:1, most preferably at least 1:1.

The cryptocrystalline magnesite-bentonite clay composite may be substantially free of at least one of brucite, fosterite, calcite and plagioclase, where substantially free means less than 2% by mass concentration.

The cryptocrystalline magnesite and bentonite clay mixture may be at least in part from magnesite tailings from a cryptocrystalline magnesite mining operation, or may be obtained at least in part from a magnesite tailings dam.

The cryptocrystalline magnesite and bentonite clay mixture or composite may be for use to treat contaminated water to remove one or more contaminants from the water.

### BRIEF DESCRIPTION OF THE DRAWINGS

The invention is now described by way of example with reference to the following examples and drawings.

In the drawings:

FIG. 1 shows XRD patterns of cryptocrystalline magnesite (1), bentonite clay (2), a composite (3) of magnesite and bentonite clay, and AMD-reacted composite (4);

FIG. 2 shows FTIR Spectra for magnesite (sample 1), bentonite clay (sample 3), composite of magnesite and bentonite clay (sample 5), and AMD-reacted composite (sample 6);

FIG. 3 shows morphological properties of magnesite-bentonite clay composite (FIG. 3—A, C and E) and AMD-reacted magnesite-bentonite clay composite (FIG. 3—B, D and F);

FIG. 4 shows SEM-EDS elemental composition of cryptocrystalline magnesite (1), bentonite clay (2) and magnesite-bentonite clay composite (3);

FIG. 5 shows SEM-EDS elemental composition of AMD-reacted magnesite-bentonite clay composite;

FIG. 6 shows graphs of variation in % removal of Fe³⁺, Al³⁺, Mn²⁺ and sulphate as a function of solid to solid ratios (Conditions: 2000 mg/L Fe³⁺, 200 mg/L Al³+, 100 mg/L Mn²+, 6000 mg/L SO₄²⁻, 60 minutes shaking time, 100 mL SAMD solution, 32 μm particle size, 250 rpm shaking speed, 26° C. temperature);

FIG. 7 shows graphs of variation of Al, Fe, Mn and SO₄²⁻ with agitation time and variation of pH with agitation time (Conditions: 2000 mg/L Fe³+, 200 mg/L Al³+, 100 mg/L Mn²⁺, 6000 mg/L SO₄²⁻, 1 g composite, 100 mL SAMD solution, 1; 100 S/L ratios, 32 μm particle size, 250 rpm shaking speed, 26° C. ambient temperature);

FIG. 8 shows pseudo-first-order plots of Mn, Al, Fe and sulphate ions adsorbed on magnesite-bentonite clay composite;

FIG. 9 shows pseudo-second-order plots of Mn, Al, Fe and sulphate ions adsorbed on magnesite-bentonite clay composite;

FIG. 10 shows intraparticle diffusion plots of Mn, Al, Fe and sulphate ions adsorbed on the composite;

FIG. 11 shows graphs of variation of pH, Al, Fe, Mn and sulphate concentration with adsorbent dosage (Conditions: 2000 mg/L Fe³⁺, 200 mg/L Al³⁺, 100 mg/L Mn²+, 6000 mg/L SO₄²⁻, 100 mL solution, 250 rpm shaking speed, <32 μm particle size, 30 minutes reaction, 26° C. temperature);

FIG. 12 shows variation in % removal and adsorption capacity of Al³⁺, Mn²⁺ and Fe^{3+/2+} as a function of ion concentration (30 minutes of shaking, <32 μm particle size, 1 g composite, 100 mL, 1:100 S/L ratios, 250 rpm shaking speed, and 26° C. ambient temperature);

FIG. 13 shows bar graphs of variation of pH gradient with varying sulphate concentrations;

FIG. 14 shows XRD patterns obtained by TEM, including a spectrum for run-of mine cryptocrystalline magnesite; and

FIG. 15 shows XRD patterns obtained by TEM, including a spectrum for synthesised cryptocrystalline magnesite.

### DETAILED DESCRIPTION OF THE INVENTION

As described hereinafter in more detail, a magnesite-bentonite clay composite was synthesized at 1:1 weight to weight ratios. The composite was mixed with contaminated water in the form of simulated AMD at specific solid-liquid (S/L) ratios, equilibrated and its capacity to neutralize and remove the concentrations of selected and potentially toxic chemical species from synthetic and field AMD evaluated at optimized conditions. The geochemical computer code PHREEQC and WATEQ4 database was used for geochemical modeling of the contaminated water. Resulting solids residues were analyzed by X-ray fluorescence (XRF), X-ray Diffraction, scanning electron microscopy (SEM) and scanning electron microscopy-energy dispersive X-ray spectroscopy (SEM-EDS), and Fourier Transforms infrared Spectroscopy (FTIR) in an attempt to detect the minerals phases controlling the inorganic contaminants concentration in solution. Interaction of the composite with AMD led to an increase in pH (pH>11) and lowering of metal concentrations. The removal of Al³⁺, Fe^{3+/2+}, Mn²⁺ and SO₄²⁻ was optimum at about 20 minutes of equilibration and 1 g of adsorbent dosage. The composite removed ≈99% (Al³⁺, Fe³⁺, and Mn²⁺) and ≈90% (SO₄²⁻) from raw mine effluent. Minor elements such as Co, Cu, Zn, Ni and Pb were also removed significantly. Surprisingly, the synthesized composite showed a significantly better removal ability of heavy metals and SO₄²⁻ from highly acidic solutions as compared to cryptocrystalline magnesite and bentonite clay individually. Adsorption kinetics fitted well to pseudo-second-order kinetic rather than to pseudo-first-order kinetic, hence confirming chemisorption. Adsorption data fitted well to Freundlich adsorption isotherm rather than to Langmuir, hence confirming multilayer adsorption. Gibbs free energy model predicted that the reaction is spontaneous in nature for Al, Fe and sulphate but not for Mn. Geochemical model indicated that Fe was removed as Fe(OH)₃, goethite and jarosite, Al as basaluminite, boehmite and jurbanite, Al(OH)₃ and as gibbsite and diaspore. Al and Fe precipitated as iron (oxy)-hydroxides and aluminium (oxy)-hydroxides. Mn precipitated as rhodochrosite and manganite. Ca was removed as gypsum. Sulphate was removed as gypsum and as Fe, Al hydroxyl sulphate minerals. Mg was removed as brucite and dolomite. This would explain the decrease in the metal species and sulphate concentration in the contaminated water. The composite of the invention removed the contaminants to below South African legal requirements for water use.

### EXAMPLES

1. Materials and Methods

1.1 Sampling

Raw magnesite rocks from the Folovhodwe Magnesite Mine in Limpopo Province, South Africa, were collected without any prior processing. Bentonite clay was supplied by ECCA (Pty) Ltd (Cape Town, South Africa). Raw AMD samples were collected from a disused mine shaft near Krugersdorp, Gauteng Province, South Africa.

1.2 Preparation of Cryptocrystalline Magnesite and Bentonite Clay

Magnesite rock samples were milled to a fine powder (Retsch RS 200 mill) and sieved (32 μm particle sizes). The raw bentonite was washed by soaking in ultra-pure water and draining after 10 minutes. The ultrapure water used was such that it covered the entire sample in the beaker and was allowed to overflow. The procedure was repeated four times. The washed bentonite was dried (24 h at 105° C.). The dried samples were milled into a fine powder (Retsch RS 200 mill) and sieved (32 μm particle size sieves).

1.3 Composite Preparation

Mechanochemical synthesis was used as a method for preparation of the clay composite. A vibratory ball-mill was used for making the porous magnesite-bentonite clay composite. Powdered bentonite (500 g) and magnesite (500 g) were mixed on a 1:1 wt % mass ratio. The mixture was crushed and homogenised by pulverizing into a fine powder (Retsch RS 200 mill) for 30 minutes at 1600 rpm. After sieving (<32 μm particle size), the material was kept in sealed plastic bags (Zip-lock).

1.4 Simulated AMD

Synthetic acid mine drainage (SAMD) was used for experimentation as real AMD is extremely difficult to work with in optimization studies due to oxidation and hydrolysis on exposure to the open leading to rapid changes in chemistry. A simplified solution containing the major ions found in AMD was prepared as described by Tutu, H., Mccarthy, T. S. & Cukrowska, E. 2008. The chemical characteristics of acid mine drainage with particular reference to sources, distribution and remediation: The Witwatersrand Basin, South Africa as a case study. Applied Geochemistry, 23(12):3666-3684.

TABLE 1
SAMD used in this study

| Salt dissolved | Species | Concentration |
|---|---|---|
| Al₂(SO₄)₃•18H₂O | Al³⁺ | 200 mg/L |
| Fe₂(SO₄)₃•H₂O | Fe³⁺ | 2000 mg/L |
| MnCl₂ | Mn²⁺ | 100 mg/L |
| H₂SO₄ and Al and Fe salts | SO₄²⁻ | 6000 mg/L |

The composition of SAMD used in this study is shown in Table 1. AMD was simulated by dissolving the following quantities of salts in 1000 mL of Milli-Q ultra-pure water (18MΩ), 7.48 g Fe₂(SO₄)₃.H₂O, 2.46 g Al₂(SO₄)₃.18H₂O, and 0.48 g MnCl₂ to give a solution of 2000 mg/L Fe³⁺, 200 mg/L Al³⁺ and 200 mg/L Mn²⁺. and 5 mL of 0.05 M H₂SO₄ was added to make up the SO₄²⁻ concentration to 6000 mg/L. The salts were dissolved in 1000 mL volumetric flasks. Prior to the addition of ferric sulphate, 5 mL of 0.05 M of H₂SO₄ was added to ensure a pH<3, in order to prevent immediate precipitation of ferric hydroxide. For batch experiments, the working solutions were prepared from these stock solutions by appropriate dilutions.

1.5 Characterization of Aqueous Solution

pH, Total Dissolved Solids (TDS) and Electrical Conductivity (EC) were monitored using a ORISON MM40 portable pH/EC/TDS/Temperature multimeter probe. Aqueous samples were analysed using ICP-MS (7500 ce, Agilent, Alpharetta, Ga., USA) for metal cations and sulphate was analysed using IC (850 professional IC Metrohm, Herisau, Switzerland). The accuracy of the analysis was monitored by analysis of National Institute of Standards and Technology (NIST) water standards.

1.6 Mineralogical, Chemical and Microstructural Characterisation

Mineralogical composition of composite and resulting solid residues was determined using XRD. Analyses were performed by using a Philip PW 1710 diffractometer equipped with graphite secondary monochromatic. Elemental composition was determined using XRF (Thermo Fisher ARL-9400 XP+ Sequential XRF with WinXRF software). XRF and XRD were done at the University of Pretoria, South Africa. Morphology was determined using SEM-EDS (JOEL JSM-840, Hitachi, Tokyo, Japan), Surface area and porosity were determined using BET (Micromeritics Tristar II, Norcross, Ga., USA). pH_{PZC} was determined using a solid addition method.

1.7 Experimental Procedures

To determine the optimum condition for AMD treatment, several operational parameters were optimised and they include: Effect of solid to liquid ratios, shaking time, composite dosage, and species concentrations. All experiments were performed in triplicate and the data averaged.

1.7.1 Effect of Cryptocrystalline Magnesite:Bentonite Clay Ratios

The effects of cryptocrystalline magnesite contents on neutralization and attenuation of metal species and sulphate was assessed. Portions (100 mL) of SAMD were pipetted into 250 mL flasks into which 1 g of the composite samples were added. The magnesite to bentonite clay (wt %) was varied as follow: 0.1:1, 0.2:1, 1:1, 2:1, 3:1, 4:1. The mixture was equilibrated for 60 minutes on a reciprocating shaker. The initial pH of the working solutions was <3. After shaking, the mixture was filtered through a 0.45 μm pore nitrate cellulose filter membrane. The filtrates were preserved by adding two drops of concentrated HNO₃ acid to prevent aging and immediate precipitation of Al, Fe and Mn and refrigerated at 4° C. prior to analysis by an inductively coupled plasma mass spectrometer (ICP-MS) (7500ce, Agilent, Alpheretta, Ga., USA). The pH before and after agitation was measured using a ORISON multimeter probe (model MM40). A separate set was left un-acidified for sulphates analysis by Ion Chromatograph (850 professional IC Metrohm, Herisau, Switzerland).

1.7.2 Effect of Time

Portions (100 mL) each of SAMD were pipetted into 250 mL flasks into which 1 g of the composite samples were added. The mixtures were then equilibrated for 1, 10, 20, 60, 120, 180, 240, 300 and 360 minutes at 250 rpm using a Stuart reciprocating shaker. The pH, metal species and sulphates contents were determined as described hereinbefore.

1.7.3 Effect of Dosage

Portions (100 mL) each of SAMD were pipetted into 250 mL flasks and varying masses (0.1-8 g) of the composite were added into each flask, respectively. The mixtures were agitated using a shaker for an optimum time of 30 minutes at 250 rpm. The pH, metal species and sulphate contents were determined as described hereinbefore.

1.7.4 Effect of Species Concentration

To investigate the effects of adsorbate concentration on reaction kinetics, several dilutions were made from the simulated AMD stock solution. The pH of the simulated AMD samples was not adjusted. The capacity of the adsorbent to neutralize and attenuate metal concentrations from aqueous solution was then assessed by increasing metal concentrations. Solutions of 100 mL each and containing 100-2000 mg/L Fe³⁺; 10-200 mg/L Al³+; 5-100 mg/L Mn²⁺ and 300-6000 mg/L SO₄²⁻ were prepared in triplicate and 1 g of the composite was added to each sample container. The mixtures were equilibrated by shaking for 30 minutes. The initial pH of the working solutions was <3. The pH, metal and sulphate contents were determined as described in the preceding section.

1.7.5 Treatment of Field AMD at Optimized Conditions

Field AMD samples were treated at established optimized conditions in order to assess the effectiveness of magnesite-bentonite clay composite treatment. The pH and metal species contents were determined as described previously while a separate set of samples was left un-acidified for SO₄²⁻ analysis. Metal species were assayed using ICP-MS, pH, EC and TDS were measured as described previously. The resultant solid residue, after contact with AMD, was characterized in order to gain an insight into the fates of chemical species after magnesite-bentonite clay composite treatment.

1.7.6 Calculation of Metal Species, Sulphate Removal and Adsorption Capacity

Computation of % removal and adsorption capacity was done using equations (5) and (6).

$$\begin{matrix}Percentage removal ( \% ) = ( \frac{Co - Ce}{Co} ) \times 100 & ( 5 ) \\ Adsorption capacity ( {q}_{e} ) = \frac{( {C}_{i} - {C}_{e} ) V}{m} & ( 6 )\end{matrix}$$

Where: Co=initial concentration, Ce=equilibrium ion concentration, V=volume of solution; Cᵢ=initial concentration; m=mass of bentonite clay.

1.7.7 Adsorption Kinetics

Adsorption kinetics were evaluated using pseudo-first-order, second order kinetics and Intraparticle diffusion model as described by Falayi, T. & Ntuli, F. 2014. Removal of heavy metals and neutralisation of acid mine drainage with un-activated attapulgite. Journal of Industrial and Engineering Chemistry, 20(4):1285-1292.

1.7.8 Adsorption Isotherms and Thermodynamics

Adsorption isotherms were evaluated using Langmuir and Freundlich adsorption models (Falayi & Ntuli, 2014). Thermodynamics evaluations were done using Gibbs free energy model as described by Rusmin, R., Sarkar, B., Liu, Y., Mcclure, S. & Naidu, R. 2015. Structural evolution of chitosan-palygorskite composites and removal of aqueous lead by composite beads. Applied Surface Science, 353(0):363-375.

An error analysis was required to evaluate the fit of the adsorption isotherms to experimental data. The linear coefficient of determination (R²) was employed for the error analysis. The linear coefficient of determination was calculated by using Equation 7:

$$r = \frac{n \sum xy - ( \sum x ) ( \sum y )}{\sqrt{n ( \sum {x}^{2} ) - {( \sum x )}^{2}} - \sqrt{( \sum {y}^{2} ) - {( \sum y )}^{2}}} \qquad ( 7 )$$

Theoretically, the R² value varies from 0 to 1. The R² value shows the variation of experimental data as explained by the regression equation. In most studies, the coefficient of determination, R², was applied to determine the relationship between the experimental data and the kinetics or isotherms.

1.7.9 Geochemical Modelling

To complement chemical solution and physicochemical characterization results, the ion association model PHREEQC was used to calculate ion activities and saturation indices of mineral phases based on the pH and solution concentrations of major ions in supernatants that were analysed after water treatment at optimised conditions. Mineral phases that were likely to form during treatment of AMD with magnesite-bentonite clay composite were predicted using the PHREEQC geochemical modelling code using the WATEQ4F database (see Parkhurst, D. L. & Appelo, C. a. J. 1999. Users guide to Phreeqc (Version 2)—A computer program for speciation, batch-reactions, one-dimensional transport and inverse geochemical calculations. Water-Resources Investigations Report 99-4259).

Species which are more likely to precipitation was determined using saturation index (SI). SI<1=under-saturated solution, Si=1=saturated solution and SI>1=Supersaturated solution.

2. Results and Discussion

2.1 X-Ray Diffraction (XRD) Analysis

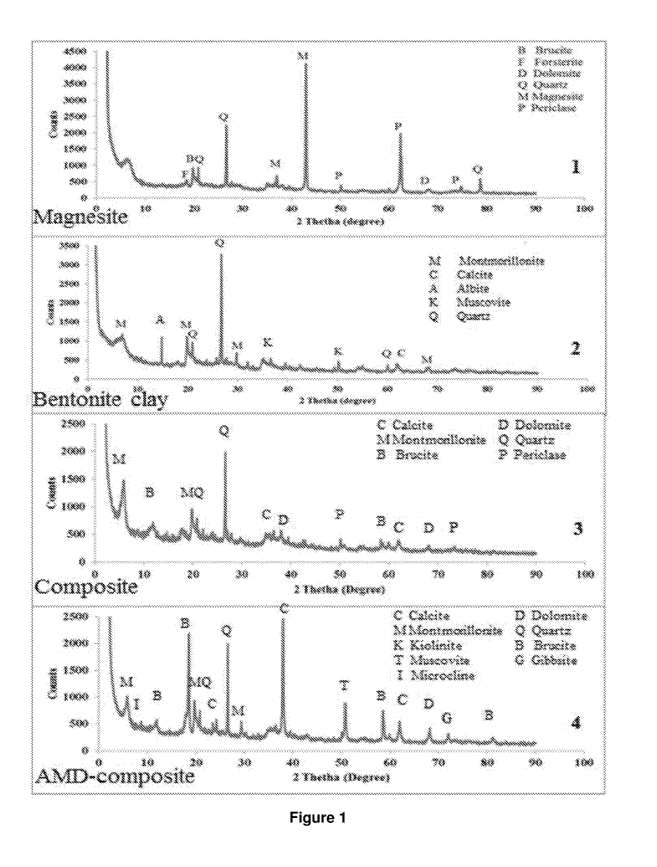

The mineralogical composition of magnesite (1), bentonite clay (2), composite (3) and AMD-reacted composite (4) is shown in FIG. 1.

XRD analysis showed that magnesite consists of magnesite, periclase, brucite, quartz and forsterite as the main mineral phases. Bentonite clay was observed to contain montmorillonite, quartz, calcite and muscovite. The composite was reported to contain montmorillonite, quartz, dolomite, calcite, brucite, periclase and muscovite. The mechanochemical synthesis of the bentonite clay in the presence of cryptocrystalline magnesite led to an amorphization of the magnesite and bentonite clay in the composite that was revealed through widening, as well as the reduction in the number and intensity of the reflection [FIG. 1(3)]. AMD-reacted composite was observed to be constituted of montmorillonite, kaolinite, microcline, quartz, dolomite, brucite, calcite, gibbsite and muscovite [FIG. 1(4)]. Quantitative mineralogical composition of cryptocrystalline magnesite (1), bentonite clay (2), composite (3) and AMD-reacted composite (4) are shown in Table 2.

Table 2: Quantitative mineralogical composition of bentonite clay, magnesite, composite and AMD-composite (Wt %)

2.2 X-Ray Fluorescence (XRF) Analysis

The elemental compositions of raw and AMD-reacted composite are shown in Tables 3 and 4.

TABLE 3
Elemental composition of raw and AMD-reacted composite

| Element (Wt %) | Raw composite | AMD-reacted composite |
|---|---|---|
| SiO₂ | 29.97 | 27.12 |
| TiO₂ | 0.22 | 0.19 |
| Al₂O₃ | 6.64 | 6.05 |
| Fe₂O₃ | 1.72 | 3.82 |
| MnO | 0.032 | 0.517 |
| MgO | 51.11 | 36.57 |
| CaO | 1.56 | 4.35 |
| Na₂O | 1.14 | 0.35 |
| K₂O | 0.51 | 0.43 |
| P₂O₅ | 0.039 | 0.033 |
| Cr₂O₃ | 0.012 | 0.020 |
| SO₃ | 0.5 | 5 |
| LOI | 6.23 | 14.91 |
| Total | 99.23 | 99.35 |
| H₂O— | 3.57 | 2.99 |

Bentonite clay is mainly comprised of Al and Si confirming that the material under study is an alumino-silicate. The presence of Fe, Mg, Ca, Na and K on clay interlayers is indicating that these are the main exchangeable cations in bentonite clay matrices. Availability of Mg, Ca, Na and K will aid in the neutralisation of AMD. Magnesite is dominated by MgO. These results corroborated reported results that cryptocrystalline magnesite is composed of close to 90% of MgO. The composite was dominated by Al, Mg and Si hence showing that the material is a combination of magnesite and a clay mineral. After contacting AMD with the composite, there was a drastic reduction in Na and K on the composite matrices. This may be described by an increase in Na and K in contaminated water post treatment. Ca, SO₃, Mn and Fe were observed to increase in a secondary residue. This may be better explained by reduction of those chemical species in treated AMD (Table 9). Notable reduction in Na, K and Mg indicates that these are the exchangeable elements on composite galleries. After interaction with AMD, the resultant solid residue was shown to be enriched with chemical species that are prevalent in AMD, showing that the composite was scavenging chemical species from AMD.

TABLE 4
Trace elemental composition of raw and reacted composite

| Elements (ppm) | Raw composite | AMD-reacted composite |
|---|---|---|
| As | <4 | 10 |
| Ba | <5 | 99 |
| Br | 16 | <2 |
| Ce | <10 | 29 |
| Co | 1.2 | 1.2 |
| Cr | 6.9 | 8.6 |
| Cs | 104 | <5 |
| Cu | 7.6 | 5.7 |
| Ga | 8.3 | 8.7 |
| Hf | 6 | <3 |
| La | <10 | 12 |
| Mo | 13 | <2 |
| Nb | 163 | 8.6 |
| Nd | 35 | 16 |
| Ni | 79 | 80 |
| Pb | 11 | 14 |
| Rb | <2 | 5.5 |
| Sc | <3 | 3.5 |
| Se | 445 | <1 |
| Sm | 17 | <10 |
| Sr | 33 | 41 |
| Ta | 18 | <2 |
| Th | 5.3 | 8.6 |
| Tl | 4.2 | <3 |
| Y | 11 | 9 |
| Zn | 8.2 | 19 |
| Zr | <2 | 60 |

Traces of Co, Cr, Cu, Ni, Pb and Zn were observed to be present in the secondary residues post treatment of AMD. This indicates that those elements were removed from AMD to secondary residues. Trace elements (Table 4) were also observed to be present at notable levels in the secondary residues hence justifying less conductivity in the composition of the treated water.

2.3 Fourier Transforms Infrared Spectroscopy (FTIR) Analysis

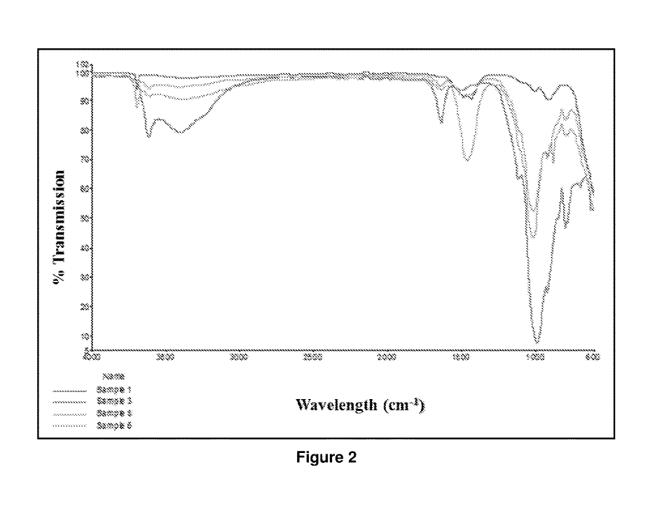

The functional groups in raw and AMD-reacted composite are shown in FIG. 2. Raw magnesite (FIG. 2, sample 1) is characterised of brucite bending corresponding to band 3702 cm⁻¹, periclase stretches corresponding to band 1500 and 950 cm⁻¹ and magnesite stretching vibration corresponding to bands 1680, 1450, 850 cm⁻¹. The doublet at 1490, 1419 cm⁻¹ corresponds to asymmetric stretching vibrations of carbonate. The reason for the split of this peak into a doublet could be due to the formation of new carbonates such as CaCO₃ and MgCO₃. The band at 1117 cm⁻¹ correspond to symmetric stretching of carbonate, and those at 886, 795 cm⁻¹ are assigned to in-plane and out-of-plane bending vibrations of carbonate ion. The presence of carbonates in raw magnesite suggests the presence of magnesite and calcite. A sharp peak at 1039 cm⁻¹ belonged to the stretching of Si—O—Si bond in montmorillonite tetrahedral sheet (FIG. 2, sample 3). A peak at 3698 cm⁻¹ was due to vibration of —OH in Mg—OH, while the vibration and bending of water molecule appeared at 3450 and 1654 cm⁻¹ respectively. A sharp peak at 3616 cm⁻¹ was assigned to the asymmetric stretching of Al—OH—Al in the aluminosilicate sheets of pristine montmorillonite (FIG. 2, sample 5). A sharp peak at 1039 cm⁻¹ is attributed to the stretching of Si—O—Si bond in montmorillonite tetrahedral sheet. A peak at 3698 cm⁻¹ is attributed to vibration of —OH in Mg—OH, while the vibration and bending of OH in water molecule appeared at 3450 and 1654 cm⁻¹ respectively. Spectroscopy results also showed that there was Si—O stretching at 1023 cm⁻¹ and Al—OH—Al bending at 917 cm⁻¹. OH stretching at region 3628-3260 cm⁻¹ shows the presence of hydroxyl groups on the composite. This will also contribute to an increase in pH during ion exchange. Moreover, the OH band at 3623 cm⁻¹ indicates the coordination of Al³⁺ with OH group. Bands in 875 cm⁻¹ and 836 cm⁻¹ correspond to Fe^{2+/3+} and Mg²⁺. The stretching at 1500 cm⁻¹ is corresponding to CO₃ stretching for calcite and magnesite. For AMD-reacted composite, CO₃ stretches were observed to be present hence indicating the formation of carbonates (FIG. 2, sample 6). A majority of characteristic absorption bands of both bentonite clay and magnesite were also present in the composite spectra, suggesting a successful blend of the material.

2.4 Scanning Electron Microscope and Electron Dispersion X-Ray (SEM-EDX)

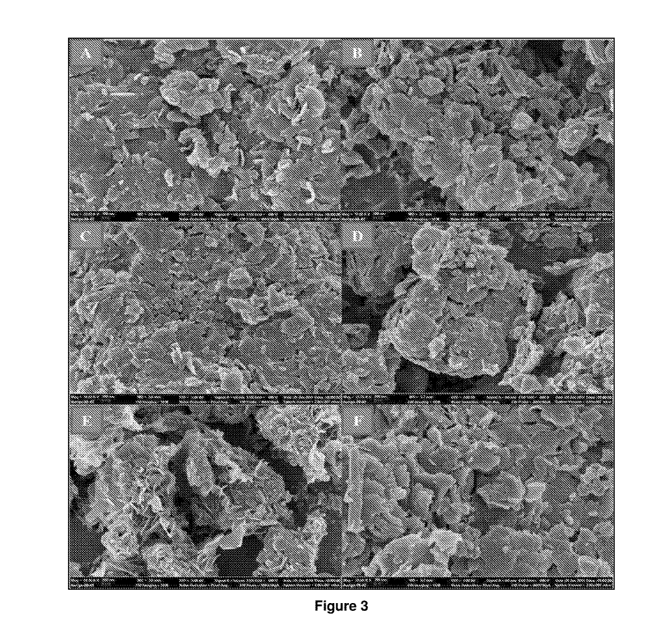

In order to better understand the mode of interaction of AMD and magnesite-bentonite clay composite and the formation of mineral phases, SEM was utilized to depict the change in morphology of the secondary solid residues as compared with the magnesite-bentonite clay composite (FIG. 3—A, C and E) and AMD-reacted magnesite-bentonite clay composite (FIG. 3—B, D and F).

The surface morphology of raw composite (FIG. 3—A, C and E) are showing that the composite contains leafy like structures and horny comb like structure meshed together. The structural morphology of AMD-reacted composite (FIG. 3—B, D and F) are showing the leafy like structures with rod like shapes compacted together. This indicates that contacting the composite with AMD did not alter the morphological properties of the clay.

The morphologies of magnesite FIG. 4 (1), bentonite clay FIG. 4 (2), and magnesite-bentonite clay composite FIG. 4 (3) are shown in FIG. 4. SEM-EDX was utilized to semi-quantitatively identify the elemental constituent in individual minerals. Spot EDS analysis was done on selected solid residue samples (FIG. 4).

The SEM results (FIG. 4) provide important information about the morphology of magnesite, bentonite clay and the composite samples. FIG. 4 (1) shows spherical aggregates on the surface of the magnesite structure. EDS revealed the presence of C, O and Mg with trace of Ca.

The SEM-EDS in FIG. 4: (2) showed that bentonite clay has sharp edges typically representing the presence of crystalline structures in raw bentonite clay. The EDS showed the presence of Al and Si at notable concentration hence indicating that they are the major species in bentonite clay structure. Fe, Mg, Ca, Na and K were observed to be presence hence indicating that these are the exchangeable cations.

The SEM-EDS in FIG. 4: (3) shows that the raw composite is characterised of irregular (heterogeneous) shape and size, and tend to be in the form of agglomerated clusters of small particles. The EDS showed that Al, Si and Mg are the major chemical species with traces of Fe, Ca, Na and K. The presence of Na, Mg, Ca and K indicates that these are the exchangeable cations on the composite interlayers. These results corroborate results obtained by XRF.

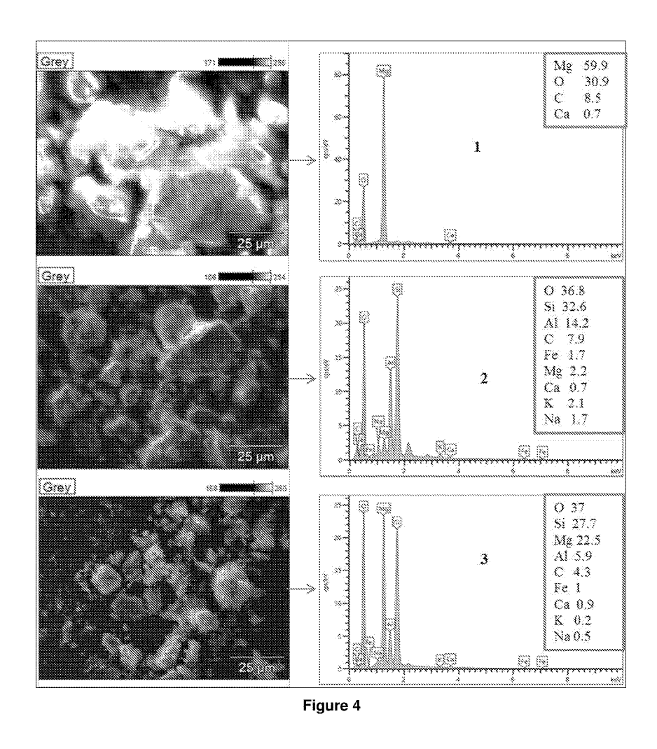

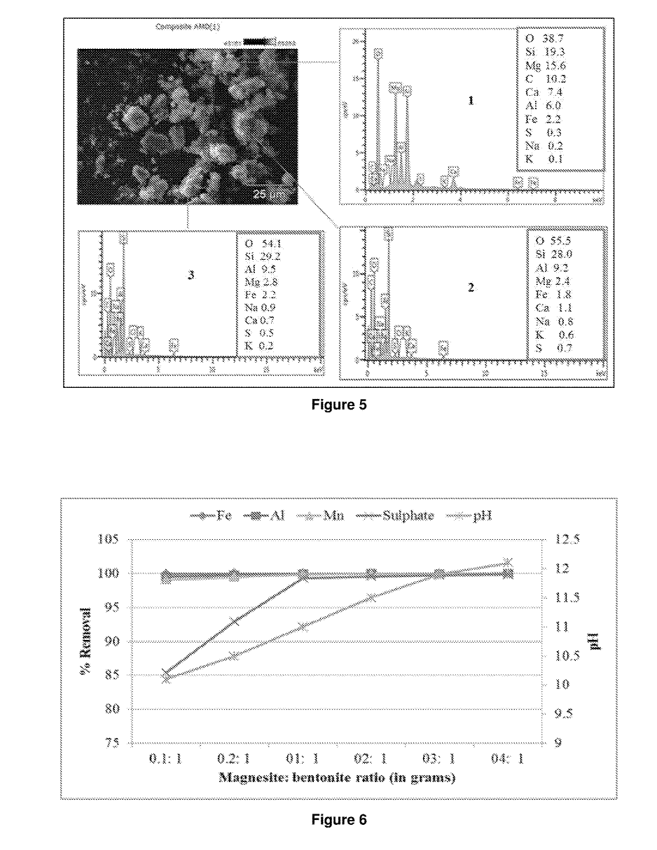

The morphology of AMD-reacted composite is shown in FIG. 5. SEM-EDX was utilized to semi-quantitatively identify the mineral phases resulting from the adsorption and neutralization reactions. Spot EDS analysis was done on selected solid residue samples.

The SEM image (FIG. 5) shows that the particles are of the order of micrometres and have irregular shapes with sharp edges. The agglomerates were observed to contain flowery lumps suspended on the surface of reacted composite.

Spot 1 (FIG. 5), revealed the presence of an increase in Al, Ca and Fe on the solid residues. This indicates that the species are removed from contaminated wastewater to solid residues. This is confirmed by the reduction of those chemical species in the treated contaminated water chemistry. The levels of Na, K and Mg were observed to have decreased. This indicates that these are the chemical species which are removed from composite interlayers when AMD is reacting with the composite since they are exchangeable cations. A decrease in Si is due to solubilisation on contact with AMD. This again indicated that bentonite clay is a sink for Fe; this was borne out by a significant reduction in levels of Fe in the treated water showing that it had been adsorbed by the bentonite clay and ion exchange (release of Na, Mg, Ca and K ions) or precipitation during the dissolution of alkaline and earth alkali metals. There was a large decrease in Na on the AMD-reacted magnesite-bentonite clay composite (FIG. 5) and an increase in Na concentration in the treated water (Table 10) demonstrating that it is a highly exchanged cation. Ca was observed to increase, confirming the XRD results which showed the presence of calcite in the AMD-reacted magnesite-bentonite clay composite. This indicated that calcite was being formed as AMD reacted with AMD-reacted magnesite-bentonite clay composite. Sulphur was also present in the AMD-reacted magnesite-bentonite clay composite complex indicating that the composite is a sink for sulphate from AMD, mainly as oxyhydroxysulphates or gypsum on the composite micro-surfaces. The presence of Fe, Al, Ca, Mg, C and O suggests minerals such as Fe, Al oxide, metals hydroxides, Fe carbonate, gypsum, Al and Fe oxyhydrosulphates. The PHREEQC simulation also predicted precipitation of mineral phases bearing these metal species.

Spot 2 (FIG. 5), revealed the presence of and an increase in Al, Ca and Fe on the solid residues. This indicates that the species are removed from wastewater to solid residues. This is confirmed by the reduction of those chemical species in the treated water chemistry. The levels of Na, K and Mg were observed to have decreased. This indicates that these are the chemical species which are removed from composite interlayers when AMD is reacting with the composite since they are exchangeable cations. A decrease in Si is due to solubilisation on contact with AMD. This again indicated that bentonite clay is a sink for Fe; this was borne out by a significant reduction in levels of Fe in the treated water showing that it had been adsorbed by the bentonite clay and ion exchange (release of Na, Mg, Ca and K ions) or precipitation during the dissolution of alkaline and earth alkali metals. There was a large decrease in Na on the AMD-reacted magnesite-bentonite clay composite (FIG. 5) and an increase in Na concentration in the treated water (Table 10) demonstrating that it is a highly exchanged cation. Ca was observed to increase, confirming the XRD results which showed the presence of calcite in the AMD-reacted magnesite-bentonite clay composite. This indicated that calcite was being formed as AMD reacted with AMD-reacted magnesite-bentonite clay composite. Sulphur was also present in the AMD-reacted magnesite-bentonite clay composite complex indicating that the composite is a sink for sulphate from AMD, mainly as oxyhydroxysulphates or gypsum on the composite micro-surfaces. The presence of Fe, Al, Ca, Mg, C and O suggests minerals such as Fe, Al oxide, metals hydroxides, Fe carbonate, gypsum, Al and Fe oxyhydrosulphates. The PHREEQC simulation also predicted precipitation of mineral phases bearing these metal species.

Spot 3 (FIG. 5), revealed the presence of an increase in Al, Ca and Fe on the solid residues. This indicates that the species are removed from contaminated wastewater to solid residues. This is confirmed by the reduction of those chemical species in the treated water chemistry. The levels of Na, K and Mg were observed to have decreased. This indicates that these are the chemical species which are removed from composite interlayers when AMD is reacting with the composite since they are exchangeable cations. A decrease in Si is due to solubilisation on contact with AMD. This again indicated that bentonite clay is a sink for Fe; this was borne out by a significant reduction in levels of Fe in the treated water showing that it had been adsorbed by the bentonite clay and ion exchange (release of Na, Mg, Ca and K ions) or precipitation during the dissolution of alkaline and earth alkali metals. There was a large decrease in Na on the AMD-reacted magnesite-bentonite clay composite (FIG. 5) and an increase in Na concentration in the treated water (Table 10) demonstrating that it is a highly exchanged cation. Ca was observed to increase, confirming the XRD results which showed the presence of calcite in the AMD-reacted magnesite-bentonite clay composite. This indicated that calcite was being formed as AMD reacted with AMD-reacted magnesite-bentonite clay composite. Sulphur was also present in the AMD-reacted magnesite-bentonite clay composite complex indicating that the composite is a sink for sulphate from AMD, mainly as oxyhydroxysulphates or gypsum on the composite micro-surfaces. The presence of Fe, Al, Ca, Mg, C and O suggests minerals such as Fe, Al oxide, metals hydroxides, Fe carbonate, gypsum, Al and Fe oxyhydrosulphates. The PHREEQC simulation also predicted precipitation of mineral phases bearing these metal species.

2.5 Brunauer-Emmett-Teller (BET) and Point of Zero Charge (PZC) Analysis

The results for surface area and pH_{PZC} for magnesite, bentonite clay, the composite and AMD-reacted composite are shown in Table 5.

TABLE 5
Surface area and PZC of magnesite, bentonite clay, magnesite-bentonite clay
composite and AMD-reacted composite

| | | Bentonite | Raw | AMD- |
|---|---|---|---|---|
| Parameters | Magnesite | clay | composite | composite |
| Surface area (m²/g) | | | | |
| Single point surface area | 16.64 | 37.05 | 18.33 | 15.94 |
| BET surface area | 16.76 | 37.21 | 18.36 | 16.17 |
| Adsorption cumulative surface area pore | 10.67 | 20.32 | 10.57 | 12.58 |
| Pore volume (cm³/g) | | | | |
| Single point pore volume | 0.079 | 0.08 | 0.07 | 0.072 |
| Cumulative volume of pores | 0.099 | 0.08 | 0.09 | 0.083 |
| Pore size (nm) | | | | |
| Adsorption average pore width | 18.80 | 8.98 | 15.75 | 17.78 |
| Adsorption average pore diameter | 37.26 | 16.49 | 35.11 | 26.39 |
| Point of Zero Charge (pH_{PZC}) | 10 | 8 | 10 | 10 |

Blending magnesite and bentonite clay resulted in a decrease in the surface area of the composite as compared to bentonite clay alone. The synthesized composite was determined to have a BET surface area of 18.36 m²/g which decreased to 16.17 m²/g after contacting with the AMD hence indicating that the vacant surfaces of the composite are occupied with specs of precipitating mineral phases which would block the pores of the composite reducing its surface area. This indicates the possible adsorption and deposition of materials to clay surfaces. The pH_{pzc} gives an insight on the type of chemical species that are more likely to be removed from aqueous solution during the reaction. When pH_{pzc} is greater than the supernatant pH, the adsorbent will adsorb anions and when the pH of the supernatant is above the pH_{pzc} the adsorbent will adsorb cations from the solution. A study by Sparks (Sparks, D. L. 1995. Environmental Soil Chemistry. Academic Press.) pointed out that aluminium and iron oxides have high pH_{PZC} values (≈8). The high pH_{PZC} of bentonite clay is due to the presence of aluminium and iron oxides or hydroxides in the clay matrix. The pH_{pzc} value of a material is a reflection of the individual pH_{pzc} values of the components present. Clay and oxide contents increase the pH_{pzc} of the material. Chemical interaction could have occurred through multidentate ligands with the surface hydroxyl groups hence leading to inner and outer layer complexes.

2.6 Inorganic contaminants removal: Batch experiments

2.6.1 Effects of magnesite to bentonite ratios

The results for inorganic contaminants attenuation as a function of magnesite to bentonite clay ratios are shown in FIG. 6.

Variation of the removal efficiencies in neutralisation and removal of metals species and sulphate by the composite with different contents of cryptocrystalline magnesite are shown in FIG. 6. It is clear that wt % of cryptocrystalline magnesite, in the composite is an important factor affecting the neutralization and removal of metals and sulphate ions from aqueous solution, especially in highly acidic environment. FIG. 6 shows that as the ratio of magnesite to bentonite increases, there was a proportional increase in pH. The pH was observed to increase from ≈10.2 to ≈12.3. This was attributed to the dissolution of magnesite and partly to the release of base cations from the bentonite clay matrices as shown in the reactions below.

MgO+H₂O→Mg²⁺=+2OH⁻ (8)

CaO+H₂O→Ca²⁺+2OH⁻ (9)

Na₂O+H₂O→2Na⁺+2OH⁻ (10)

K₂O+H₂O→2K⁺+2OH⁻ (11)

Removal of sulphate was observed to increase with an increase in the magnesite to bentonite ratio. Attenuation of the major metal species concentrations, Al, Mn and Fe remained above 99% since the pH was highly alkaline for their precipitation. At 1:1 magnesite to bentonite mass ratio all the chemical species removal was above 98% and the higher ratios seemed to have no significant difference in the removal capacity. Hence a 1:1 mass ratio ratio was taken as the optimum for the fabrication of the composite.

2.6.2 Effect of Equilibration Time

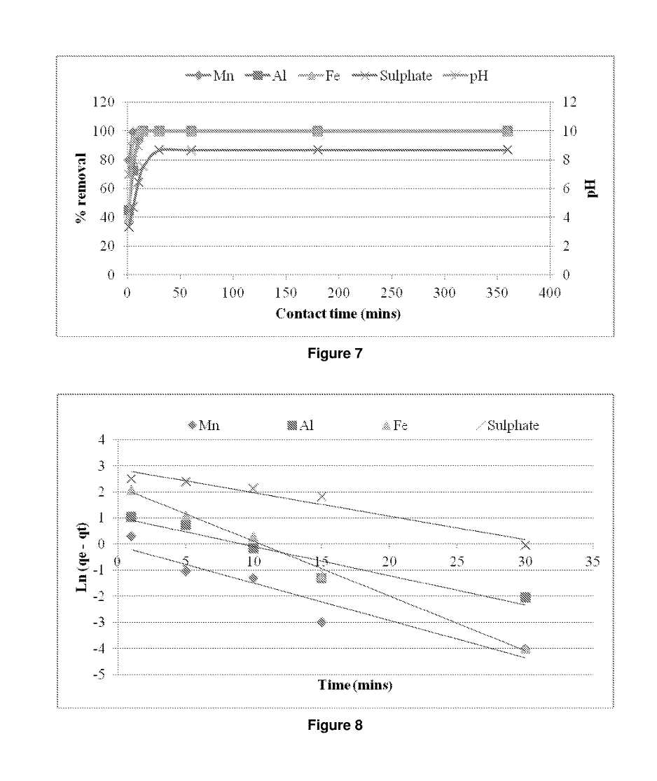

Results of metals species and sulphate removal in SAMD as a function of contact time are shown in FIG. 7. An increase in pH was observed with increases in contact time. Metal removal also increased with increased contact time. An increase in pH from 6-10 and metal concentration attenuations were observed to be high within the first 20 minutes of interaction but stabilises thereafter. An increase in pH was attributed to dissolution of magnesite, alkali and alkaline earth metal oxides from the composite during the interaction with AMD leading to an increase in alkalinity. An increase in pH also leads to precipitation of metal species from AMD. On precipitation the metal hydroxides incorporate sulphate to form various oxyhydroxysulphates and also adsorb sulphate. The composite also exchanged Al³⁺, Fe³⁺, and Mn²⁺ with cations such as Na⁺, Mg²⁺ and Ca²⁺ in their matrices; the exchanged highly charged cations could also adsorb sulphates as counter ions. The composite showed good efficiencies in the treatment of AMD since it removes chemical species from contaminated water in a single step as compared to two-step traditional treatment methods. This study also showed good removal efficiencies of chemical species (0.100% Al³⁺, Fe³⁺, and Mn²⁺ and >50% SO₄²⁻) as compared to a study conducted by Nkonyane et al. (Nkonyane, T., Ntuli, T. & Muzenda, E. 2012. Treatment of acid mine drainage using unactivated bentonite and limestone. World Academy of Science, Engineering and Technology, 68:139-144) who reported that 120 min of contact time is efficient in raising the pH to 7.5 and remove metals except for Mn when using a combination of bentonite clay and limestone. The present study achieved maximum removal within the short contact time of 20 min and raised the pH to >10 which is suitable for removal of all metal species. Therefore, 30 minutes was taken as the optimum agitation time and was used as the optimum time and applied in subsequent experiments.

2.6.3 Adsorption Kinetics and Mechanism

The effect of contact time on removal of chemical species from aqueous solution was evaluated using different kinetic models to reveal the nature of the adsorption process and rate limiting processes. Different kinetic model parameters for adsorption of Mn, Al, Fe and sulphate on the composite are shown in Table 6. A Lagergren pseudo first order kinetic model is a well-known model that is used to describe mechanisms of metal species adsorption by an adsorbent. It can be written as follows:

ln(qₛ−qₜ)=ln qₑ−k₁t (12)

Where k₁ (min⁻¹) is the pseudo-first-order adsorption rate coefficient and qₑ and qₜ are the values of the amount adsorbed per unit mass at equilibrium and at time t, respectively. The experimental data was fitted by using the pseudo-first-order kinetic model by plotting ln(qₑ−qₜ) vs. t, and the results are shown in Table 6 and FIG. 8. The pseudo-first-order was applied and it was found only to fairly converge with the experimental data. Moreover, the calculated amounts of Mn, Al, Fe and sulphate ions adsorbed by the composite [q_{e, calc} (mgg⁻¹)] were less than the experimental values [q_{e, exp} (mgg⁻¹)] (Table 6). The finding indicated that the Lagergren pseudo-first-order kinetic model is inappropriate to describe the adsorption of Mn, Al, Fe and sulphate ions from aqueous system by the composite.

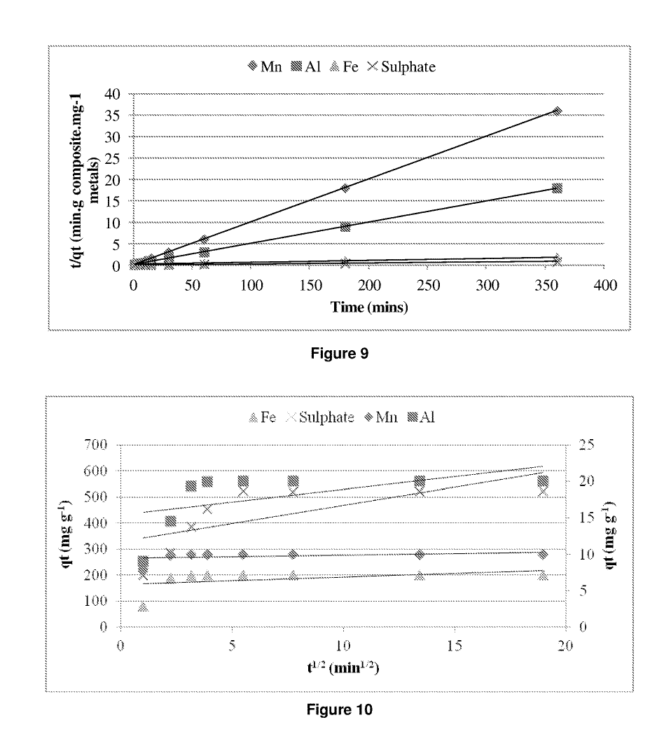

The pseudo-second-order kinetic model is another kinetic model that is widely used to describe the adsorption process from an aqueous solution. The linearized form of the pseudo-second-order rate equation is given as follow:

$$\frac{t}{qr} = \frac{1}{{k}_{2} {q}_{e}^{2}} + \frac{t}{{q}_{e}} \qquad ( 13 )$$

where k₂ [g (mg min⁻¹)] is the pseudo-second-order adsorption rate coefficient and qₑ and qₜ are the values of the amount adsorbed per unit mass at equilibrium and at time t, respectively. An application of the pseudo-second-order rate equation for adsorption of chemical species to the composite matrices portrayed a good fit with experimental data (FIGS. 9 and 10 and Table 6). The obtained results confirm that a pseudo-second-order model is the most suitable kinetic model to describe adsorption of Mn, Al, Fe and sulphate by the composite from an aqueous system. Moreover, this also confirms that the adsorption mechanism of the metals species from aqueous solution is chemisorption.

Note the theoretical adsorption capacity is close to the experimental adsorption capacity further confirming that this model describes the adsorption data (Table 6 and FIG. 9). The overall kinetics of the adsorption from solutions may be governed by diffusional processes as well as by kinetics of the surface chemical reaction. In diffusion studies, the rate is often expressed in terms of the square root time

qₜ=k_{id}t^{1/2}+Cᵢ (14)

where k_{id} (mgg⁻¹ min^{-1/2}) is the intraparticle diffusion coefficient (slope of the plot of qₜ vs. t²) (FIG. 10) and Cᵢ is the intraparticle diffusion rate constant. The results also showed that the Intraparticle diffusion model by Webber Morris was not applicable for the present process due to lower correlation coefficients.

TABLE 6
Different kinetic model parameters for adsorption of Mn, Al, Fe and
sulphate on the composite
Pseudo-first-order kinetic model

| Element | q_{e, exp} (mgg⁻¹) | q_{e, calc} (mgg⁻¹) | K₁ | R² |
|---|---|---|---|---|
| Mn | 9.99 | −11.12 | 0.177 | 0.94 |
| Al | 19.99 | −4.77 | 0.309 | 0.99 |
| Fe | 199.9 | −8.94 | 0.331 | 0.91 |
| Sulphate | 521.1 | −6.99 | 1.519 | 0.90 |

Pseudo-second-order kinetic model

| Element | q_{e, exp} (mgg⁻¹) | q_{e, calc} (mgg⁻¹) | K₂ | R₂ |
|---|---|---|---|---|
| Mn | 9.99 | 10.01 | 3.67 | 1 |
| Al | 19.99 | 20.04 | 1.24 | 1 |
| Fe | 199.9 | 200 | 1.67 | 1 |
| Sulphate | 521.1 | 526.3 | 0.69 | 0.999 |

Intraparticle diffusion model

| Element | q_{e, exp} (mgg⁻¹) | Cᵢ (mgg⁻¹) | K_{id} (mgg⁻¹ min^{-1/2}) | R² |
|---|---|---|---|---|
| Mn | 9.99 | 2.85 | 13.93 | 0.48 |
| Al | 19.99 | 2.20 | 2.89 | 0.18 |
| Fe | 199.9 | 1.02 | 0.35 | 0.29 |
| Sulphate | 521.1 | −0.06 | 0.05 | 0.17 |

The plot for adsorption of Mn, Al, Fe and sulphate on the composite using pseudo-first-order, pseudo-second-order and Intraparticle diffusion models are shown in FIGS. 8-10.

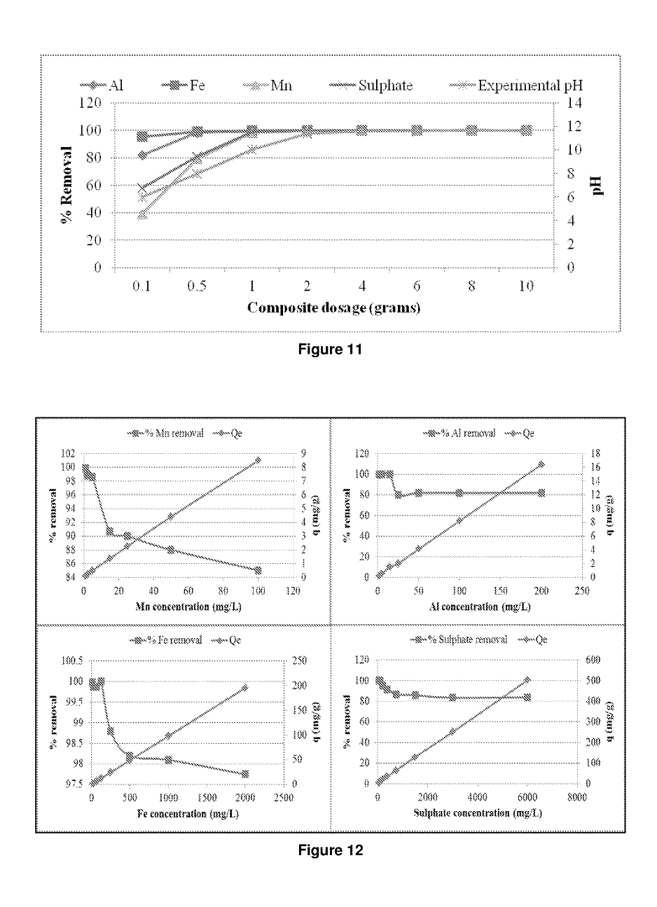

The results of neutralization and attenuation of inorganic contaminants from synthetic AMD as a function of the composite dosage are shown in FIG. 11.

FIG. 11 shows that there was an increase in pH with an increase in composite dosage. Cations and anions in the supernatant solution were also observed to decrease with an increase in dosage. The increase in pH was attributed to dissolution of magnesite, alkali and alkaline earth metal oxides from the composite during the interaction with AMD, hence leading to an increase in pH. The XRF and XRD results also indicated the presence of these oxides and carbonates in the matrices of the composite feedstock. An increase in pH also led to precipitation of metal species from AMD. On precipitation the metal hydroxides incorporate sulphates to form various oxyhydroxysulphates and also adsorb sulphates. The adsorption data could further point to chemical adsorption probably due to interaction with the [Al(H₂O)₆]³⁺ and [Fe(H₂O)₆]³⁺ incorporated to the interlayers and hydroxyl groups on the clay surfaces. When this pH is reached, small particles of the metal hydroxide are formed (Equation 15). For example sulphate could interact with those species as follows [Equations (15-17)].

Mⁿ⁺+nOH⁻→M(OH)ₙ↓ (15)

Al(H₂O⁻)₃(OH)₃+SO₄²⁻→Al(H₂O)₃(OH)(SO₄)+2OH⁻ (16)

Fe(H₂O)₃+SO₄²−→Fe(H₂O)₃(OH)(SO₄)+2OH⁻ (17)

The composite may also exchange Al³⁺, Fe³⁺, and Mn²⁺ with cations such as Na⁺, Mg²⁺ and Ca²⁺ in their matrices (Table 9). The exchanged high charge cations could also adsorb sulphates as the counter ions. As composite dosage increased, the pH increased. Moreover, the composite presented more sites for ion-exchange and adsorption of chemical species in aqueous solution. As the dosage increased, more surface sites for exchange of low density cations with high density cations from AMD become available. The composite is effective for AMD treatment since it combines ion-exchange of Mg, Ca, Na and K, adsorption, and co-precipitation and precipitation of metal species from AMD as the pH increases due to dissolution of alkaline materials hence leading to much cleaner effluents. At 1 g adsorbent dosage the attenuation capacity of the major metal species concentrations was >95%. Consequently, 1 g was taken as the optimum dosage for subsequent experiments under these conditions. The optimum dosage (10 g/L) indicated by this work compares favourably with other remediation agents such as limestone (10 g/L), dolomite (40 g/L), limestone bentonite blend (10 g/L) and fly ash (500 g/L) reported by other researchers. Moreover, the treatment efficiency of this technology is high as compared to the other technologies since it can neutralize and remove metals and sulphate to within DWAS drinking water quality guidelines. South Africa has large reserves of both bentonite and magnesite, and thus, the economic viability of this technology is high at least in South Africa.

2.6.4 Effects of Chemical Species Concentration

The results for chemical species attenuation as a function of concentration are shown in FIG. 12.

At the initial concentration evaluated the composite exhibited ≈80-100% for Al, ≈97-100% for Fe, and ≈84-100% for Mn removal efficiency. Greater than 80% sulphate removal efficiency was observed at the evaluated concentration ranges. The pH remained above 10 in all concentration gradients meaning that 30 minutes of agitation and 1 g of the composite would be adequate for neutralization and removal of contaminants from AMD under these conditions. At low concentration of metal species, more surfaces are available for adsorption and at high concentration more surfaces are occupied by pollutants. At low concentration, there is less acidity to be neutralised so the pH remain alkaline (>10). Removal of Al and Fe may be due to ion exchange of base cations (Mg, Ca, Na and K) from the composite interlayers, dissolution of magnesite leading to precipitation and co-precipitation of metal species with an increase in pH. The presence of exchangeable base metals was shown by CEC, SEM-EDS and XRF studies (Table 2 and 6). Dissolution of calcite, periclase and magnesite as shown by XRD contribute to an increase in pH that will precipitate metals as hydroxide and oxyhydrosulphates as shown by SEM-EDS point analysis (FIG. 5).

2.6.5 Adsorption Isotherms and Thermodynamics

The relationship between the amount of ions adsorbed and the ion concentration remaining in solution is described by an isotherm. The two most common isotherm models for describing this type of system are the Langmuir and Freundlich adsorption isotherms. These models describe adsorption processes on a homogenous (monolayer) or heterogeneous (multilayer) surface, respectively. The most important model of monolayer adsorption came from Langmuir. This isotherm is given as follows:

$${q}_{e} = \frac{{Q}_{0} {bC}_{e}}{1 + {bC}_{e}} \qquad ( 18 )$$

The constant Q₀ and b are characteristics of the Langmuir equation. The Langmuir isotherm is valid for monolayer sorption due to a surface with a finite number of identical sites and can be expressed in the following linear form:

$$\frac{Ce}{{Q}_{e}} = \frac{1}{{Q}_{m} b} + \frac{Ce}{{Q}_{m}} \qquad ( 19 )$$

The essential characteristics of the Langmuir isotherm can be expressed in terms of a dimensionless constant separation factor or equilibrium parameter, R_{L}, which is defined as:

$${R}_{L} = \frac{1}{1 + {bC}_{0}} \qquad ( 20 )$$

where, Ce=equilibrium concentration (mg L⁻¹), ge=amount adsorbed at equilibrium (mg g⁻¹), Qm=Langmuir constants related to adsorption capacity (mg g⁻¹) and b=Langmuir constants related to energy of adsorption (L mg⁻¹). A plot of Ce versus Ce/Qe should be linear if the data conforms to the Langmuir isotherm. The value of Qm is determined from the slope and the intercept of the plot. It is used to derive the maximum adsorption capacity and b is determined from the original equation and represents the degree of adsorption.

The Freundlich adsorption isotherm describes the heterogeneous surface energy by multilayer adsorption. The Freundlich isotherm is formulated as follows:

qₑ=kCe^{1/n} (21)

The equation may be linearised by taking the logarithm of both sides of the equation and can be expressed in linear form as follows:

$$log {q}_{e} = \frac{1}{n} log C + log K \qquad ( 22 )$$

where Ce=equilibrium concentration (mg L⁻¹), qₑ=amount adsorbed at equilibrium (mg g⁻¹), K=Partition Coefficient (mg g⁻¹) and n=degree of adsorption. A linear plot of log a versus log qₑ indicates whether the data is described by the Freundlich isotherm. The value of K implies that the energy of adsorption on a homogeneous surface is independent of surface coverage and n is an adsorption constant which reveals the rate at which adsorption is taking place. In order to fully understand the nature of adsorption the thermodynamic parameters such as Gibbs free energy change (ΔG) could be calculated. It was possible to estimate these thermodynamic parameters for adsorption reaction by considering the equilibrium constant under the experimental conditions. The Gibbs free energy change of adsorption was calculated using the following equation:

ΔG=−RT ln Kₑ (23)

where, R is gas constant (8.314 J mg⁻¹ K⁻¹), T is temperature and Kc is the equilibrium constant (K_{c}=qₑ/cₑ). A positive ΔG value indicates that the sorption process is spontaneous in nature and also feasible whereas a negative value indicates that the reaction is not spontaneous and feasible. The parameters of Langmuir and Freundlich adsorption isotherms are shown in Table 7. These two constants are determined from the slope and intercept of the plot of each isotherm. The parameters of Langmuir and Freundlich adsorption isotherms are shown in Table 7.

TABLE 7
Parameters of Langmuir and Freundlich adsorption isotherm
and thermodynamics

| | Langmuir | | | | | | | |
|---|---|---|---|---|---|---|---|---|
| | | | | | ΔG/ | Freundlich | | |
| | | | b | | 1000 | | | K_{f} (mg |
| Element | R² | R_{L} | (L mg⁻¹) | Qₘₐₓ | (kJ/mg) | R² | n | g⁻¹) |
| Al | 0.71 | 0.031 | 0.3 | 8.9 | 53.32 | 0.96 | 2.1 | 149 |
| Fe | 0.45 | 0.049 | 0.1 | 15.7 | 73.81 | 0.85 | 2.8 | 7.07 |
| Mn | 0.66 | 0.046 | 0.1 | 200 | −137.89 | 0.82 | 2.5 | 1.95 |
| SO₄²⁻ | 0.55 | 0.062 | 0.002 | 588.2 | 62.80 | 0.92 | 2.3 | 2.4 |

The results showed better fit to Freundlich adsorption isotherm than Langmuir adsorption isotherm hence confirming multilayer adsorption. Qₘₐₓ and b were determined from the slope and intercept of the plot and were found to be 8.9, 15.7, 200, 588.2 mg/g and 0.3, 0.1, 0.1, 0.002 L/mg for Mn, Al, Fe and sulphate, respectively. According to Sparks et al. (Sparks, D. L. & Sparks, D. L. 2003. Environmental Soil Chemistry. Academic Press), R_{L} values between 0 and 1 indicate favourable adsorption. The R_{L} were found to range from 0.031 to 0.062 hence showing that it was favourable. K_{f} and n were calculated from the slopes of the Freundlich plots. The constants were found to be K_{f}=149, 7.07, 1.95, 2.4 and n=2.1, 2.8, 2.5, 2.3 for Mn, Al, Fe and sulphate, respectively. According to Langmuir (Langmuir, D. 1997. Aqueous Environmental Geochemistry. Prentice Hall), n values between 1 and 10 represent beneficial adsorption. This showed that adsorption of ions from aqueous solution by the composite was favourable. Gibbs free energy model predicted that the reaction is spontaneous in nature for Al, Fe and sulphate except for Mn.

2.7 Variation of pH with an Increase in Fe³⁺ Concentration

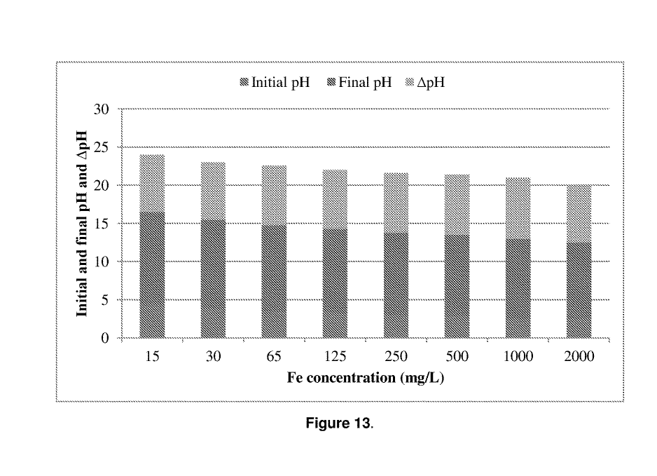

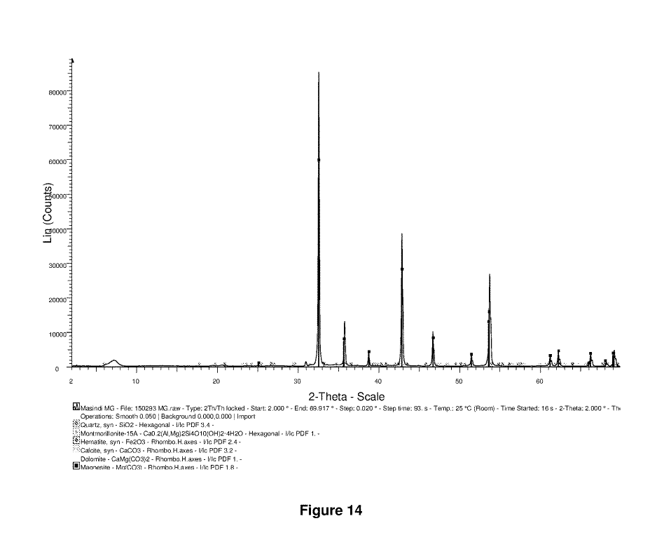

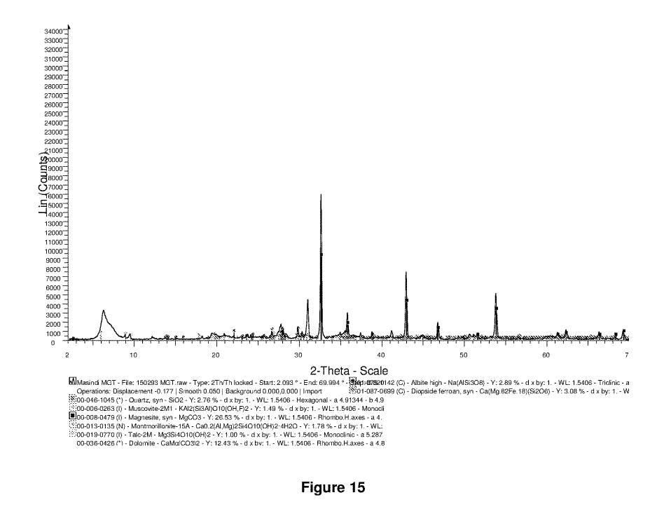

The variation of pH profile with varying concentration of Fe³⁺ as representative of the inorganic contaminants in the SAMD is shown in FIG. 13. As the metal concentration increases, the initial pH was gradually decreasing; this may be attributed to hydrolysis of metal cations with the release of H⁺ cations.

Fe³⁺+H₂O→Fe(OH)₃₍ₛ₎+H⁺ (24)

Al³⁺+H₂O→Al(OH)₃₍ₛ₎+H⁺ (25)

Mn²⁺+H₂O→Mn(OH)₂₍ₛ₎+H⁺ (26)

As shown in FIG. 13, drastic increases in final pH were observed at varying Fe concentrations. Increases in pH were attributed to dissolution of calcite, periclase and magnesite, and release of base metal species from the clay matrices to aqueous solution. Adsorption of sulphate onto clay matrices with release of hydroxyl groups may also have contributed to increases in pH of the aqueous solutions.

2.8 Calculation of Saturation Indices (SI) for Various Mineral Phases

The results for calculation of mineral precipitation at various pH values during treatment of simulated AMD with magnesite-bentonite clay composite are presented in Table 8.

TABLE 8
Calculation of SI for selected mineral phases at various pH

| | pH and saturation indices (SI) | | | | | |
|---|---|---|---|---|---|---|
| Mineral phase | 3 | 4 | 6 | 8 | 10 | 11 |
| Alkalinity (eq/Kg) | −3.6 × 10⁻² | 1.5 × 10⁻² | 6.4 × 10⁻² | 3 × 10⁻¹ | −3 × 10⁻¹ | 3.5 |
| Al(OH)₃ | −0.9 | 3.5 | 2.9 | 1.2 | −0.1 | −1.5 |
| Boehmite (AlOOH) | −0.5 | 7 | 5 | 3.4 | 2.1 | 0.7 |
| Basaluminite Al₄(OH)₁₀SO₄ | −0.8 | 23 | 17.4 | 6 | −1.4 | −10.2 |
| Brucite Mg(OH)₂ | −11 | −9 | −6.6 | −2 | 0.6 | 3.6 |
| Calcite | −11 | −2.3 | −1.5 | 1.8 | 3.4 | 4 |
| Aragonite | −8.6 | −2.5 | −0.2 | 1.7 | 3.7 | 3.8 |
| Diaspore (AlOOH) | −0.9 | 8.3 | 6.8 | 5.1 | 3.1 | 2 |
| Dolomite CaMg(CO₃)₂ | −6 | −2.5 | −1.3 | 4.9 | 6.9 | 8 |
| Epsomite | −7 | −4 | −2 | −1.8 | −1.8 | −1.8 |
| Fe(OH)₃ | 5 | 4.4 | 3.7 | 4.6 | 3.2 | 3.1 |
| Gibbsite Al(OH)₃ | 0.3 | 6.7 | 5.5 | 3.7 | 1.8 | 0.8 |
| Geothite (FeOOH) | 6 | 8 | 9.7 | 10.5 | 9.1 | 9 |
| Gypsum (CaSO₄•H₂O) | −0.1 | −0.2 | −0.2 | 4 | 5 | 8 |
| Jarosite H (H₃O)Fe₃(SO₄)₂(OH)₆ | 5 | 3.2 | 2.9 | −3.7 | −16 | −20 |
| Jurbanite (AlOHSO₄) | 1 | 5 | 2.5 | −3.6 | −9.8 | −12.8 |
| Rhodochrosite (MnCO₃) | −8.75 | −0.9 | −0.4 | 0 | 0 | 0 |
| Manganite MnOOH | −8.1 | −5.3 | −2.9 | 4 | 6 | 8 |
| Pyrochroite Mn(OH)₂ | −8 | −7.1 | −6.4 | 0.2 | 0.9 | 2.2 |

As shown in Table 8, Fe could precipitate as hydroxides at pH>3. Al could precipitate as hydroxides at pH>4. Mn could precipitates as hydroxide at pH>10 and rhodochrosite at pH>8. Sulphate-bearing minerals could precipitates at pH 6-8 (basaluminite), pH>8 (gypsum), pH 6 (jarosite and jurbanite). PHREEQC predicted mineral phases to precipitate as metal hydroxides, hydroxysulphates and oxyhydroxysulphates. However, sulphates were removed from solution together with Al, Fe and Ca. This corroborates the SEM-EDX and XRF detected Al, Fe, Mn and S rich mineral phases deposited to solid residues. This indicates that the Al, Fe, Mn and S rich mineral phases were too amorphous to be detected by XRD or the concentration was below the detection limits. To be particular, the presence of Mn, Fe, Al, Ca, Mg, C and O suggests precipitation of minerals such as Mn, Fe, Al oxide, metals hydroxides, Mn and Fe carbonate, gypsum, Al and Fe oxyhydrosulphates; this was validated by PHREEQC geochemical model and SEM-EDS.

2.9 Treatment of Field AMD at Optimized Conditions

The results of AMD treatment with bentonite clay, magnesite and the composite are shown in Table 9.

TABLE 9
Chemical composition of raw AMD before and after treatment (chemical
species in mg L⁻¹)

| | | | Bentonite | | Composite |
|---|---|---|---|---|---|
| Parameter | Field | DWAS | treated | Magnesite | treated |
| (mg/L) | AMD | Guidelines | AMD | treated AMD | AMD |
| pH | 2.3 | 6-10 | 6 | 10.3 | 11.1 |
| TDS | 10237 | 0-1200 | 9872 | 4345.2 | 1145 |
| EC | 22713 | 0-700 | 16425 | 4635.6 | 2635 |
| Na | 171 | 0-50 | 316 | 164 | 223 |
| K | 18 | NA | 17 | 17 | 15 |
| Mg | 183 | 0-30 | 192 | 402 | 350 |
| Ca | 762 | 0-32 | 566 | 302 | 379 |
| Al | 190 | 0-0.9 | 1.1 | <0.03 | <0.03 |
| Fe | 259 | 0-0.1 | 15 | <0.02 | 0.01 |
| Mn | 40 | 0-0.05 | 35 | 0.04 | 0.001 |
| Cu | 7.80 | 0-1 | 0.1 | <0.05 | <0.005 |
| Zn | 7.90 | 0-0.5 | 6.3 | 0.1 | <0.01 |
| Pb | 6.30 | 0-0.01 | 0.1 | 0.2 | <0.01 |
| Co | 41.30 | NA | 44.7 | 0.2 | <0.01 |
| Ni | 16.60 | 0-0.07 | 24.4 | 0.5 | <0.01 |
| As | 20 | 0.001 | 0.05 | <0.01 | <0.01 |
| B | 5 | 0.01 | 0.2 | <0.01 | <0.01 |
| Cr | 20 | 0.01 | 0.1 | <0.01 | <0.01 |
| Mo | 16 | 0.01 | 0.6 | <0.01 | <0.01 |
| Se | 17 | 0.02 | 0.9 | <0.01 | <0.01 |
| Si | 1.49 | NA | 5.29 | 5.7 | 0.6 |
| SO₄²⁻ | 4000 | 0-500 | 3454 | 1913 | 916 |

DWAS = South African Department of Water Affairs and Sanitation

In field AMD the major ions are Ca, Mg, Na, Al, Fe and sulphate. After treatment, the resultant water had an increased pH with reduced metal species and sulphate concentrations. The composite treatment yielded water to within the DWAS Water Quality Guidelines. Bentonite showed insignificant increases in pH and a slight reduction in metal species. This showed that the treatment is effective for wastewater with low metal concentrations and as such it can be used as a polishing process. Contact of cryptocrystalline magnesite at optimised conditions produced water conforming to the DWAS Water Quality Guidelines except for pH, EC, TDS, Mg and sulphate. A combination of magnesite and bentonite clay treatment increased the pH of the solution significantly and yielded water conforming to DWAS Guidelines. The pH was >11, major metals removal was >99%, oxyanions of As, B, Cr, Mo, Se and sulphate were also >90% and alkalis and earth alkaline metals removal was >60% hence seeking a polishing technology to remove alkaline metals.

The vibratory ball mill was successfully used for the synthesis of the cryptocrystalline magnesite and bentonite clay composite. The pronounced efficiencies in neutralization and attenuation of inorganic contaminants from AMD were observed to be superior as compared to bentonite clay and cryptocrystalline magnesite individually. It was observed that the best conditions for synthesis of the composite are 1:1 mass ratio. Milling improved the physicochemical properties of the composite hence making the composite an excellent material for neutralization and attenuation of inorganic contaminants simultaneously. The magnesite-bentonite composite has the capacity to neutralize AMD and remove potentially toxic chemical species. Optimization experiments revealed that 20 min of equilibration and a 1 g of composite dosage were the optimum conditions under laboratory conditions for treatment of AMD at 1:100 S/L ratios. Four processes were observed to govern the removal of inorganic contaminants from AMD using the composite, namely, (1) adsorption, (2) ion-exchange (3) precipitation and (4) co-precipitation. The adsorption process fitted pseudo-second-order kinetics rather than pseudo-first-order kinetics, confirming that the step governing chemical reaction is chemisorption. In adsorption modeling the data conformed better to the Freundlich adsorption isotherm than to the Langmuir adsorption isotherm hence confirming multilayer adsorption. An increase in the levels of base cations in the treated water as shown by ICP-MS and a decrease in the secondary residue as shown by XRF, and SEM-EDS indicate that ion exchange was one of the mechanisms that were taking place during the removal of metal species from contaminated water bodies. PHREEQC geochemical model, revealed that Fe, Al, Mn, and Ca formed sulphate-bearing minerals. SEM-EDS, disclosed that the presence of Fe, Al, Ca, Mg, C and O suggest minerals such as Fe, Al oxide, metals hydroxides, Fe carbonate, gypsum, Al and Fe oxyhydrosulphates are formed as precipitates or co-precipitates. From modeling simulations, the formation of these phases follow a selective precipitation sequence with Fe³⁺ at pH>6, Al³⁺ at pH>6, Fe²⁺ at pH>8, Mn²⁺, Ca²⁺ and Mg²⁺ at pH>10. The composite proved to be effective for treatment of AMD as compared to traditional wastewater treatment methods such as limestone, magnesite, clays, lime and bentonite blend. It also produced water of useable standard for industrial and agricultural purposes. This study showed that magnesite and bentonite clay composite can be an efficient and effective technology for treatment of AMD.

1. A process for the treatment of contaminated water, the process including contacting the contaminated water with a cryptocrystalline magnesite-bentonite clay composite thereby to remove one or more contaminants from the water.

2. The process claimed in claim 1, wherein the contaminated water comprises metal or metalloid ions as contaminants and wherein contacting the contaminated water with a cryptocrystalline magnesite-bentonite clay composite includes mixing particulate cryptocrystalline magnesite-bentonite clay composite with the contaminated water thereby to remove at least some of the metal or metalloid ion contaminants from the water.

3. The process claimed in claim 1, wherein the contaminated water comprises oxyanions of one or more elements selected from the group consisting of arsenic, chromium, boron, selenium and molybdenum and said oxyanions are removed from the contaminated water by contact with the cryptocrystalline magnesite-bentonite clay composite.

4. The process claimed in claim 1, wherein contacting the contaminated water with cryptocrystalline magnesite-bentonite clay composite includes using sufficient cryptocrystalline magnesite-bentonite clay composite to raise the pH of the water to >10.

5. The process claimed in claim 2, wherein the metal ions removed from the water as contaminants are selected from the group consisting of Al, Mn, Ca, and Fe ions.

6. The process claimed in claim 2, wherein the metal ions removed from the water as contaminants are divalent ions selected from the group consisting of Co(II), Cu(II), Ni(II), Pb(II) and Zn(II).

7. The process claimed in claim 1, wherein the cryptocrystalline magnesite-bentonite clay composite is in particulate form and has a particle size such that the particulate cryptocrystalline magnesite-bentonite clay composite is able to pass through a 125 μm particle size sieve.

8. The process claimed in claim 1, wherein the contaminated water is contacted with cryptocrystalline magnesite-bentonite clay composite at a solid/liquid ratio of 0.5 kg-10 kg:10L-150L.

9. The process claimed in claim 1, wherein the contaminated water is contacted with cryptocrystalline magnesite-bentonite clay composite for 10 to 80 minutes.

10. The process claimed in claim 1, wherein the contaminated water is acid mine drainage.

11. The process claimed of claim 1, wherein the contaminated water is industrial waste water containing metal or metalloid ions.

12. The process claimed in claim 11, wherein the industrial waste water comprises divalent metal ions.

13. The process claimed in claim 12, wherein the divalent metal ions are selected from the group consisting of Co(II), Cu(II), Ni(II), Pb(II) and Zn(II).

14. The process claimed in claim 3, wherein the oxyanions are selected from the group consisting of sulphates, phosphates and nitrates.

15. The process claimed in claim 1, wherein the cryptocrystalline magnesite-bentonite clay composite has a magnesite-bentonite clay mass ratio of at least 0.2:1.

16. The process claimed in claim 1, wherein the contaminated water comprises sulphate at a concentration of up to 6000 mg/L and wherein the cryptocrystalline magnesite-bentonite clay composite removes at least 60% of the sulphate from the contaminated water.

17. The process claimed in claim 1, in which the cryptocrystalline magnesite-bentonite clay composite is obtained at least in part from magnesite tailings from a cryptocrystalline magnesite mining operation, or is obtained at least in part from a magnesite tailings dam.

18. A method for the manufacture of a cryptocrystalline magnesite-bentonite clay composite, the method including
milling an admixture of cryptocrystalline magnesite and bentonite clay to a desired particle size with amorphization of the magnesite and bentonite clay in the resultant cryptocrystalline magnesite-bentonite clay composite.

19. The method claimed in claim 18, which includes admixing cryptocrystalline magnesite powder and bentonite clay powder to provide said admixture.

20. The method claimed in claim 18, in which the cryptocrystalline magnesite and bentonite clay admixture is obtained at least in part from magnesite tailings from a cryptocrystalline magnesite mining operation, or is obtained at least in part from a magnesite tailings dam.

21. The method claimed in claim 19, in which the cryptocrystalline magnesite powder and the bentonite clay powder are admixed in a mass ratio of at least 0.2:1.

22. The method claimed in claim 18, in which the milling of the admixture renders the cryptocrystalline magnesite-bentonite clay composite substantially free of at least one of brucite, fosterite, calcite and plagioclase, where substantially free means less than 2% by mass concentration.

23. The method claimed in claim 18, in which the milled cryptocrystalline magnesite-bentonite clay composite has a reduced concentration of at least one of periclase, smectite, quartz and muscovite compared to the concentration in magnesite for periclase and the concentration in bentonite clay for smectite, quartz and muscovite.

24. The method claimed in claim 18, wherein the resultant cryptocrystalline magnesite-bentonite clay composite has a particle size such that the particulate cryptocrystalline magnesite-bentonite clay composite is able to pass through a 125 μm particle size sieve.

25. A cryptocrystalline magnesite-bentonite clay composite comprising a powdered admixture of cryptocrystalline magnesite powder and bentonite clay powder with a magnesite-bentonite clay mass ratio of at least 0.2:1.

26. The cryptocrystalline magnesite-bentonite clay composite of claim 25, wherein the magnesite-bentonite clay mass ratio is at least 0.5:1.

27. The cryptocrystalline magnesite-bentonite clay composite of claim 25 which is substantially free of at least one of brucite, fosterite, calcite and plagioclase, where substantially free means less than 2% by mass concentration.

28. The cryptocrystalline magnesite-bentonite clay composite of claim 25, wherein the cryptocrystalline magnesite-bentonite clay composite has a particle size such that the particulate cryptocrystalline magnesite-bentonite clay composite is able to pass through a 125 μm particle size sieve.

29. A cryptocrystalline magnesite-bentonite clay composite comprising a powdered mixture of cryptocrystalline magnesite and bentonite clay which has a particle size such that the particulate cryptocrystalline magnesite-bentonite clay composite is able to pass through a 125 μm particle size sieve.

30. The cryptocrystalline magnesite-bentonite clay composite of claim 29, which has a particle size such that the particulate cryptocrystalline magnesite-bentonite clay composite is able to pass through a 75 μm particle size sieve.

31. The cryptocrystalline magnesite-bentonite clay composite of claim 29, wherein the magnesite-bentonite clay mass ratio is at least 0.5:1.

32. The cryptocrystalline magnesite-bentonite clay composite of claim 29, which is substantially free of at least one of brucite, fosterite, calcite and plagioclase, where substantially free means less than 2% by mass concentration.

33. The cryptocrystalline magnesite-bentonite clay composite of claim 29, in which the cryptocrystalline magnesite and bentonite clay mixture is obtained at least in part from magnesite tailings from a cryptocrystalline magnesite mining operation, or is obtained at least in part from a magnesite tailings dam.
